(19) United States
(12) Patent Application Publication
(10) Pub. No.: US 2016/0191460 A1
(43) Pub. Date: Jun. 30, 2016

(54) FORWARDING A DHCP PACKET

(71) Applicant: HANGZHOU H3C TECHNOLOGIES CO., LTD., Hangzhou, Zhejiang (CN)

(72) Inventor: Xiaohui CUI, Beijing (CN)

(73) Assignee: Hangzhou H3C Technologies Co., Ltd., Hangzhou City (CN)

(21) Appl. No.: 14/899,819

(22) PCT Filed: Sep. 11, 2014
(86) PCT No.: PCT/CN2014/086275

§ 371 Date: Dec. 18, 2015

(30) Foreign Application Priority Data
Sep. 13, 2013 (CN) 201310418600.5

(51) Int. Cl. H04L 29/12; H04L 12/751; H04L 29/06

(52) U.S. Cl. CPC H04L 61/2015; H04L 67/42; H04L 45/02

(57) ABSTRACT

According to an example, a relay device receives a DHCP request packet sent from a DHCP client, in which the DHCP request packet includes a user information sub-option including a node identifier of the DHCP client. The relay device adds a node identifier of the relay device and path information of receiving the DHCP request packet by the relay device to a relay agent information sub-option in the DHCP request packet, and forwards the DHCP request packet to a DHCP server, so that the DHCP server determines network topology according to the user information sub-option and the relay agent information sub-option.

### BACKGROUND

Based on a client/server communication model, dynamic host configuration protocol (DHCP) can dynamically configure network configuration parameters, such as internet protocol (IP) addresses, for network devices.

### BRIEF DESCRIPTION OF THE DRAWINGS

Features of the present disclosure are illustrated by way of example and not limited in the following figure(s), in which like numerals indicate like elements, in which:

FIG. 1 is a schematic diagram illustrating DHCP networking, according to an example of the present disclosure.

FIG. 2A is a flowchart illustrating a method for forwarding a DHCP packet, according to an example of the present disclosure.

FIG. 2B is a flowchart illustrating a method for forwarding a DHCP packet, according to an example of the present disclosure.

FIG. 2C is a flowchart illustrating a method for forwarding a DHCP packet, according to an example of the present disclosure.

FIG. 3 is a schematic diagram illustrating a structure of the Option 82 sub-option, according to an example of the present disclosure.

FIG. 4 is a schematic diagram illustrating a structure of a relay device, according to an example of the present disclosure.

FIG. 5 is a schematic diagram illustrating a structure of a relay device, according to another example of the present disclosure.

### DETAILED DESCRIPTION

Hereinafter, the present disclosure will be described in further detail with reference to the accompanying drawings and examples.

In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, and the term “including” means including but not limited to. The term “based on” means based at least in part on. In addition, the terms “a” and “an” are intended to denote at least one of a particular element.

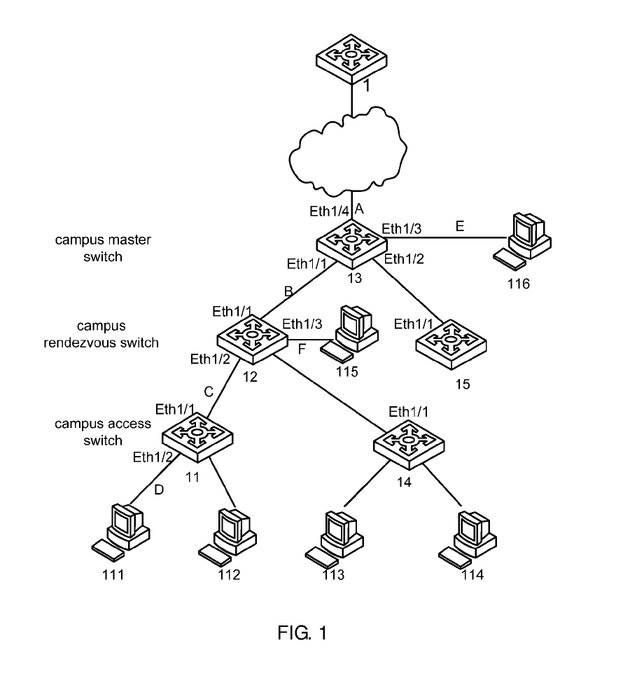

FIG. 1 is a schematic diagram illustrating a DHCP network, according to an example of the present disclosure. As shown in FIG. 1, the network may include a DHCP server 1, DHCP clients 111 to 116, and relay devices 11 to 15. When a DHCP client and a DHCP server are not in a same network segment, there may be a relay device between the DHCP client and the DHCP server. According to an example of the present disclosure, dynamic configuration of IP addresses for each functional entity as shown in FIG. 1 may be implemented in a following way.

At block S1, DHCP client 111 may broadcast a DISCOVER packet.

At block S2, relay devices 11 to 13 may send, based on configurations, the DISCOVER packet to DHCP server 1 in a unicast manner.

At block S3, DHCP server 1 may configure an IP address for DHCP client 111 and send an OFFER packet to relay devices 11 to 13 in the unicast manner, in which the OFFER packet may carry the configured IP address.

At block S4, relay devices 11 to 13 may send the OFFER packet to DHCP client 111 in the unicast manner.

At block S5, DHCP client 111 may broadcast a REQUEST packet, in which the REQUEST packet may carry the IP address configured by DHCP server 1 for DHCP client 111.

At block S6, relay devices 11 to 13 may send, based on the configurations, the REQUEST packet to DHCP server 1 in the unicast manner.

At block S7, DHCP server 1 may send, in the unicast manner, an acknowledgment (ACK) packet to relay devices 11 to 13 to confirm configuration of the IP address and to configure a lease for DHCP client 111.

At block S8, relay devices 11 to 13 may send, in the unicast manner, the ACK packet to DHCP client 111.

At block S9, according to the DHCP protocol, DHCP client 111 may send, in the unicast manner, a lease-extending packet to DHCP server 1 via relay devices 11 to 13 in certain time, so as to ensure the IP address is available.

According to various examples of the present disclosure, the DISCOVER packet and the REQUEST packet as described above may be collectively called a DHCP request packet.

In general, entities implementing the dynamic configuration of the IP address such as network devices, servers, and personal computers (PCs) of users may come from different vendors, as such, functions of information sub-options supported by these entities may not be uniform. For example, a relay agent information sub-option Option82 supported by relay devices of some vendors may not have an additional item, and therefore supplementary path information may not be added. However, Option82 supported by relay devices of some other vendors may add the supplementary path information. As such, in case the devices come from different vendors and the Option82 is carried by the DHCP packet as described above, network topology may be difficultly collected, and the network devices and the PCs of the users may be difficultly monitored and managed.

According to various examples of the present disclosure, in order to enable a DHCP server to collect the network topology, the DHCP request packet may carry two information sub-options, one is a user information sub-option and the other is a relay agent information sub-option. In this case, the user information sub-option is Option60, configured to indicate attributes of a user. Not only may a DHCP client send a packet carrying Option60, but also a relay device may send a packet carrying Option60, in which the relay device may serve as a DHCP client. The relay agent information sub-option is Option82, configured to indicate path information of a packet. Option82 may be carried in a packet sent by the relay device. It should be noted that information sub-options may be multiple values between 0 to 254 depending on different functions.

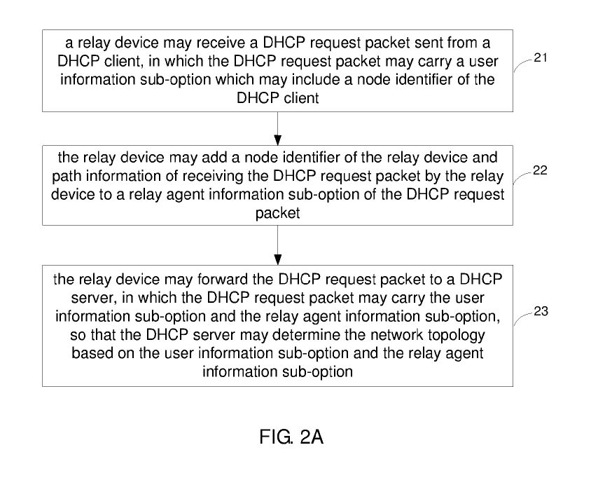

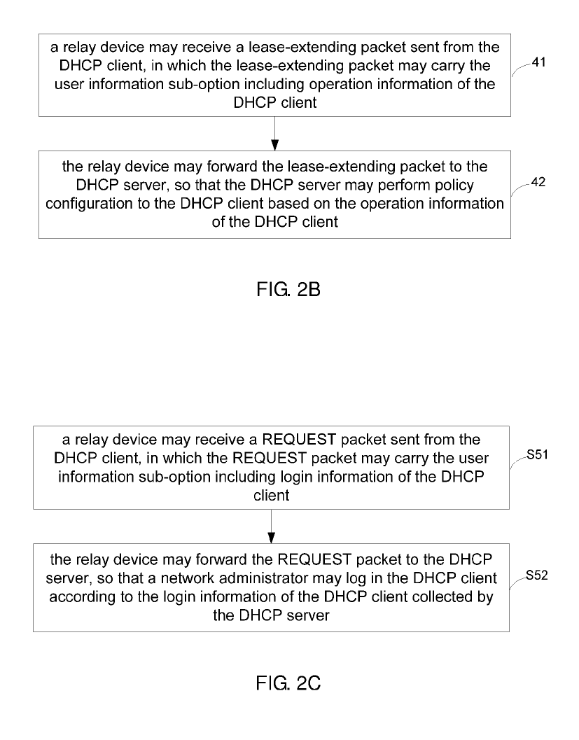

FIG. 2A is a flowchart illustrating a method for forwarding a DHCP packet, according to an example of the present disclosure. The method may include following operations.

In block 21, a relay device may receive a DHCP request packet sent from a DHCP client, in which the DHCP request packet may carry a user information sub-option which may include a node identifier of the DHCP client.

In block 22, the relay device may add a node identifier of the relay device and path information of receiving the DHCP request packet by the relay device to a relay agent information sub-option of the DHCP request packet.

In this case, the path information of receiving the DHCP request packet by the relay device may include information about an interface on the relay device receiving the DHCP request packet and information about an interface on the relay device forwarding the DHCP request packet.

In block 23, the relay device may forward the DHCP request packet to a DHCP server, in which the DHCP request packet may carry the user information sub-option and the relay agent information sub-option, so that the DHCP server may determine the network topology based on the user information sub-option and the relay agent information sub-option.

According to various examples of the present disclosure, the above DHCP request packet may be a DISCOVER packet (also called a DHCP-DISCOVER packet) or a REQUEST packet (also called a DHCP-REQUEST packet). Hereinafter, the method as described above may be described in further detail taking the networking as shown in FIG. 1 as an example.

At step SS1, DHCP client 111 may initiate a DISCOVER request to relay device 11, in other words, DHCP client 111 may send a DISCOVER packet to relay device 11. In this case, the DISCOVER packet may carry Option60 of which contents may include a node identifier of DHCP client 111. According to an example of the present disclosure, the node identifier may include fields such as a vendor identifier, a device category, and a device type, etc.

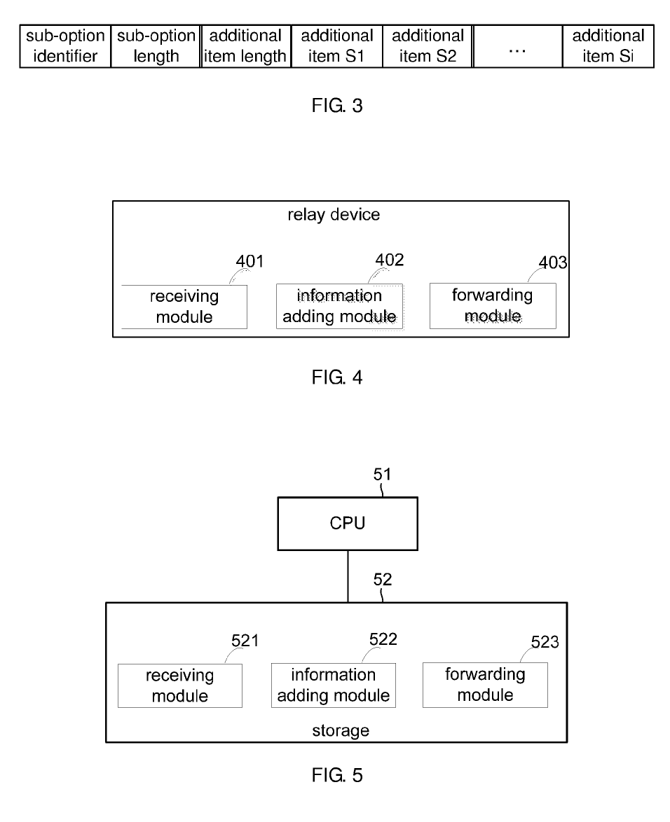

At step SS2, relay device 11 may add Option82 to the DISCOVER packet and send the DISCOVER packet to relay device 12. According to an example of the present disclosure, the structure of Option82 may be shown in FIG. 3, including an identifier of the sub-option, the length of the sub-option, the length of an additional item, and the additional item. According to an example of the present disclosure, there may be N additional items, which may be denoted as additional item Si (i=1, 2, . . . N), in which N is an integer. Each additional item field may be filled with an identifier of a relay device and path information of receiving the DHCP request packet (in this case, the DHCP request packet may be the DISCOVER packet) by the relay device. At step SS2, the DISCOVER packet sent by relay device 11 may carry Option60 and Option82, in which an additional item of Option82 may include a device identifier of relay device 11, an ingress port Eth1/2 through which relay device 11 receives the DISCOVER packet, and an egress port Eth1/1 through which relay device 11 forwards the DISCOVER packet.

At step SS3, relay device 12 may add a device identifier of relay device 12, an ingress port Eth1/2 through which relay device 12 receives the DISCOVER packet, and an egress port Eth1/1 through which relay device 12 forwards the DISCOVER packet to Option82 carried in the DISCOVER packet received by relay device 12. Relay device 12 may send the DISCOVER packet to relay device 13.

At this time, there are two additional items in Option82, in which additional item 1 may include the device identifier of relay device 11, the ingress port Eth1/2 through which relay device 11 receives the DISCOVER packet, and the egress port Eth1/1 through which relay device 11 forwards the DISCOVER packet; additional item 2 may include the device identifier of relay device 12, the ingress port Eth1/2 through which relay device 12 receives the DISCOVER packet, and the egress port Eth1/1 through which relay device 12 forwards the DISCOVER packet.

At step SS4, relay device 13 may add a device identifier of relay device 13, an ingress port Eth1/1 through which relay device 13 receives the DISCOVER packet, and an egress port Eth1/4 through which relay device 13 forwards the DISCOVER packet to Option82 carried in the DISCOVER packet received by relay device 13. Relay device 13 may send the DISCOVER packet to DHCP server 1.

At this time, there are three additional items in Option82, in which additional item 1 may include the device identifier of relay device 11, the ingress port Eth1/2 through which relay device 11 receives the DISCOVER packet, and the egress port Eth1/1 through which relay device 11 forwards the DISCOVER packet; additional item 2 may include the device identifier of relay device 12, the ingress port Eth1/2 through which relay device 12 receives the DISCOVER packet, and the egress port Eth1/1 through which relay device 12 forwards the DISCOVER packet; and additional item 3 may include the device identifier of relay device 13, the ingress port Eth1/1 through which relay device 13 receives the DISCOVER packet, and the egress port Eth1/4 through which relay device 13 forwards the DISCOVER packet.

At step SS5, DHCP server 1 may receive the DISCOVER packet. DHCP server 1 may determine that node devices in a path from DHCP client 111 to DHCP server 1 may include DHCP client 111, relay device 11, relay device 12, and relay device 13. In addition, DHCP server 1 may determine a link from DHCP client 111 to relay device 13.

Based on the same method as described above, DHCP server 1 may obtain the network topology as shown in FIG. 1.

Since Option60 may indicate attributes of a user, operation information of the user may be carried by Option60. As such, according to an example of the present disclosure, in order to implement real-time monitoring to the node devices, when a DHCP server receives a DISCOVER packet and configures an IP address and a lease for a DHCP client, the method for forwarding a DHCP packet may further include following operations, as shown in FIG. 2B.

In block 41, a relay device may receive a lease-extending packet sent from the DHCP client, in which the lease-extending packet may carry the user information sub-option including operation information of the DHCP client.

In block 42, the relay device may forward the lease-extending packet to the DHCP server, so that the DHCP server may perform policy configuration to the DHCP client based on the operation information of the DHCP client.

According to an example of the present disclosure, the operation information of the DHCP client may include any combination of the following information including CPU occupancy of the DHCP client, an interface state of each interface on the DHCP client, interface uplink traffic statistics, and interface downlink traffic statistics. According to an example of the present disclosure, the operation information of the DHCP client may be stored on a remote server. As such, the user information sub-option in the lease-extending packet may carry an address and a domain name of the remote server where the DHCP client remotely stores information (e.g., the operation information of the DHCP client), and a user name and a password required for logging in the remote server.

In this way, the DHCP client may send traffic information of the DHCP client to the DHCP server, in which the traffic information may be carried in the lease-extending packet. As such, traffic information of each DHCP client may be displayed on the DHCP server in real time, and thus a network administrator may conveniently monitor the whole network. When it is found that abnormal traffic erupts at a network port on a device in the network, the DHCP server may be controlled to notify the device to disable the network port through policy configuration, so as to protect the network. For example, when receiving information indicating that abnormal traffic erupts at a port on the DHCP client, the DHCP server may add an Option sub-option to an ACK packet (also called a DHCP-ACK packet) that may be sent to the DHCP client subsequently, in which the Option sub-option may carry information of the port on the DHCP client to be disabled. As such, when the DHCP client receives the Option sub-option, the DHCP client may disable the port with the abnormal traffic.

According to an example of the present disclosure, the DHCP server may determine, based on the collected network information, the network topology through a WEB or a gateway software. When the network administrator wants to log in a DHCP client, the network administrator may click on an icon of the DHCP client on a management client, and thus the network administrator may search out a way for logging in the DHCP client through an identifier of the DHCP client and ultimately log in the DHCP client. In this case, pre-configuration may be performed in a policy database of the DHCP server, or the DHCP server has dynamically collected a way for logging in each DHCP client. Since Option 60 may indicate attributes of a user, login information of the user may be carried by Option 60. As such, according to an example of the present disclosure, when a DHCP server receives a DISCOVER packet and configures an IP address for a DHCP client, the method for forwarding a DHCP packet may further include following operations, as shown in FIG. 2C.

In block S51, a relay device may receive a REQUEST packet sent from the DHCP client, in which the REQUEST packet may carry the user information sub-option including login information of the DHCP client.

In block S52, the relay device may forward the REQUEST packet to the DHCP server, so that a network administrator may log in the DHCP client according to the login information of the DHCP client collected by the DHCP server.

According to an example of the present disclosure, the login information may include a system identifier used by the DHCP client, such as windows or comware; a network management mode employed by the DHCP client, such as remote login, telnet or HTTP; a service port number, a user name, and a password required for logging in the DHCP client; an address and a domain name of a remote server where the DHCP client remotely stores information, and a user name and a password required for logging in the remote server. In this case, the address of the remote server may include a media access control (MAC) address or an internet rotocol (IP) address of the remote server.

By this manner, as long as a user selects the DHCP client in the network topology determined by the DHCP server, the DHCP server may automatically search for an address and an access method associated with the DHCP client and initiate a service process, so as to manage the login of the DHCP client.

It should be noted that in the method described above, the login information of the DHCP client may be sent to the DHCP server through the REQUEST packet. When the DHCP server receives a DHCP-DISCOVER packet sent from the DHCP client, searching of the login information of the DHCP client may be triggered, as well. According to an example of the present disclosure, when the login information of the DHCP client is not searched out, in a DHCP-OFFER packet sent from the DHCP server to the DHCP client, the DHCP client may be designated to return the login information to the DHCP server. Subsequently, the designated DHCP client may send a DHCP-REQUEST packet to the DHCP server, in which the DHCP-REQUEST packet may carry the login information of the DHCP client. When receiving the login information of the DHCP client, the DHCP server may store the login information. When the user selects the DHCP client for login, the DHCP server may provide a login service for the user.

In view of the above, since Option60 may indicate attributes of a user, Option60 may carry a user identifier, operation information of the user, and login information of the user. According to various examples of the present disclosure, a DHCP client may send Option60 to a DHCP server through a relay device. In addition, the relay device may serve as a DHCP client. In this case, the relay device may send attribute information of the relay device to the DHCP server. As such, the term “DHCP client” in the above examples of the present disclosure may not specifically refer to “DHCP client 111”. When a relay device serves as a DHCP client, functions of the relay device may be the same as those of “DHCP client 111”. As such, the DHCP server may obtain operation information and login information of each node device.

In addition, after the DHCP server obtains the network topology, an access path between node devices may be determined. According to various examples of the present disclosure, the DHCP server may run a routing protocol and perform routing learning. When a relay device serves as a DHCP client, the relay device may not run the routing protocol, instead, the DHCP server may issue routing information to the relay device. The DHCP server may issue information about a next hop of the relay device in an access path towards a destination client to the relay device through adding an information sub-option Option33 or Option121 to the ACK packet. As such, a routing entry may be formed in the relay device serving as the DHCP client, in which the routing entry may be configured to forward traffic to the destination client. For example, DHCP client 111 is to access DHCP client 116, and an IP address configured by DHCP server 1 for DHCP client 116 is 1.1.1.1. In this case, DHCP server 1 may issue to relay device 11 information about a next hop of relay device 11 in an access path from DHCP client 111 to DHCP client 116, in which the next hop is relay device 12. As such, a local routing entry formed in relay device 11 may be shown in Table 1.

TABLE 1

| Destination IP address | Egress port | IP address of the next hop |
|---|---|---|
| 1.1.1.1 | Eth1/1 | IP address of relay device 12 |

DHCP server 1 may issue to relay device 12 information about a next hop of relay device 12 in the access path from DHCP client 111 to DHCP client 116, in which the next hop is relay device 13. As such, a local routing entry formed in relay device 12 may be shown in Table 2.

TABLE 2

| Destination IP address | Egress port | IP address of the next hop |
|---|---|---|
| 1.1.1.1 | Eth1/1 | IP address of relay device 13 |

DHCP server 1 may issue to relay device 13 information about a next hop of relay device 13 in the access path from DHCP client 111 to DHCP client 116, in which the next hop is DHCP client 116. As such, a local routing entry formed in relay device 13 may be shown in Table 3.

TABLE 3

| Destination IP address | Egress port | IP address of the next hop |
|---|---|---|
| 1.1.1.1 | Eth1/3 | 1.1.1.1 |

In this way, when DHCP client 111 accesses DHCP client 116, traffic from DHCP client 111 may be firstly forwarded to the default gateway relay device 11. According to the routing entry as shown in Table 1, the traffic may be forwarded to relay device 12. According to the routing entry as shown in Table 2, the traffic may be forwarded to relay device 13. According to the routing entry as shown in Table 3, the traffic may be forwarded to the destination DHCP client 116. By this manner, the traffic may be forwarded without running the routing protocol between the node devices.

According to another example of the present disclosure, the DHCP client may add a media access control (MAC) address of the DHCP client to a DHCP-DISCOVER packet or a DHCP-REQUEST packet, and may send the DHCP-DISCOVER packet or the DHCP-REQUEST packet to the DHCP server. When the DHCP server returns a DHCP-ACK packet to the DHCP client, a correspondence relationship between the IP address and the MAC address of the DHCP client may be carried in the DHCP-ACK packet. When receiving the correspondence relationship, the relay device may store the correspondence relationship. According to an example of the present disclosure, when a user is a valid user, the user may send a DHCP packet to the DHCP server to request an IP address. When the DHCP server returns the DHCP-ACK packet, a correspondence relationship between an IP address and a MAC address of the user may be carried in the DHCP-ACK packet. When the user is an invalid user, the IP address of the user may be configured by the user privately, and thus the user may not send the DHCP packet to the DHCP server to request the IP address. As such, the correspondence relationship between the IP address and the MAC address of the user may not exist. By this manner, the relay device may receive the correspondence relationship between the IP address and the MAC address of the valid user. For example, in the networking as shown in FIG. 1, relay device 11 is connected to DHCP client 111 and DHCP client 112, respectively. Assuming DHCP client 111 is a valid user and DHCP client 112 is an invalid user, when DHCP client 112 wants to access the network, a correspondence relationship between an IP address and a MAC address of DHCP client 112 may not be found on relay device 11. As such, DHCP client 112 may not access network resources, and thus security of an intranet may be ensured.

It should be noted that a backup device of the relay device may not store the correspondence relationship between the IP address and the MAC address of the valid DHCP client. According to an example of the present disclosure, the DHCP server may send the correspondence relationship between the IP address and the MAC address of the DHCP client to the backup device through an information sub-option between Option224 and Option254, in which the backup device serves as a DHCP client and the information sub-option may carry the correspondence relationship between the IP address and the MAC address of the DHCP client. As such, when traffic is shifted to the backup device, the backup device may ensure the security of the intranet.

Based on the method as described above, various examples of the present disclosure may further describe a relay device, which may be applied to the above method. FIG. 4 is a schematic diagram illustrating a structure of the relay device. As shown in FIG. 4, the relay device may include a receiving module 401, an information adding module 402, and a forwarding module 403.

The receiving module 401 may receive a DHCP request packet sent from a DHCP client, in which the DHCP request packet may carry a user information sub-option including a node identifier of the DHCP client.

The information adding module 402 may add a node identifier of the relay device and path information of receiving the DHCP request packet by the relay device to a relay agent information sub-option in the DHCP request packet.

The forwarding module 403 may forward the DHCP request packet to a DHCP server, in which the DHCP request packet may carry the user information sub-option and the relay agent information sub-option. As such, the DHCP server may determine the network topology according to the user information sub-option and the relay agent information sub-option.

According to an example of the present disclosure, the receiving module 401 may receive a lease-extending packet sent from the DHCP client, in which the lease-extending packet may include the user information sub-option including operation information of the DHCP client.

The forwarding module 403 may forward the lease-extending packet to the DHCP server, so that the DHCP server may perform policy configuration to the DHCP client based on the operation information of the DHCP client.

According to an example of the present disclosure, the receiving module 401 may receive a REQUEST packet sent from the DHCP client, in which the REQUEST packet may include the user information sub-option including login information of the DHCP client.

The forwarding module 403 may forward the REQUEST packet to the DHCP server, so that a network administrator may log in the DHCP client according to the login information of the DHCP client collected by the DHCP server.

According to an example of the present disclosure, when the relay device serves as a DHCP client, the receiving module 401 may receive information about a next hop of the relay device in an access path towards a destination client, in which the information about the next hop may be carried in an ACK packet sent by the DHCP server and issued by the DHCP server through a running routing protocol. The receiving module 401 may form a routing entry in the relay device, in which the routing entry may be configured to forward traffic to the destination client.

According to an example of the present disclosure, when the relay device serves as a DHCP client, the receiving module 401 may receive a correspondence relationship between an IP address and a MAC address of the DHCP client, in which the correspondence relationship may be carried in an ACK packet sent from the DHCP server. The receiving module 401 may store the correspondence relationship, so that the DHCP client may validly access network resources based on the correspondence relationship.

The above-mentioned modules in the examples of the present disclosure may be deployed either in a centralized or a distributed configuration, and may be either merged into a single module, or further split into a plurality of sub-modules.

These modules may be implemented by hardware, such as a general purpose processor, in combination with machine readable instructions stored in a computer readable medium and executable by the processor, or by dedicated hardware (e.g., the processor of an Application Specific Integrated Circuit (ASIC)), Field Programmable Gate Array (FPGA) or a combination thereof.

FIG. 5 is a schematic diagram illustrating a structure of the relay device, according to another example of the present disclosure. As shown in FIG. 5, the relay device may include a central processing unit (CPU) 51 and a storage 52. The storage 52 may include machine-readable instruction modules to be executed by the CPU 51, in which the machine-readable instruction modules may include a receiving module 521, an information adding module 522, and a forwarding module 523. The CPU 51 may communicate with the storage 52 and execute the machine-readable instruction modules included in the storage 52.

The receiving module 521 may receive a DHCP request packet sent from a DHCP client, in which the DHCP request packet may include a user information sub-option including a node identifier of the DHCP client.

The information adding module 522 may add a node identifier of the relay device and path information of receiving the DHCP request packet by the relay device to a relay agent information sub-option in the DHCP request packet.

The forwarding module 523 may forward the DHCP request packet to a DHCP server, in which the DHCP request packet may include the user information sub-option and the relay agent information sub-option. As such, the DHCP server may determine the network topology according to the user information sub-option and the relay agent information sub-option.

According to an example of the present disclosure, the receiving module 521 may receive a lease-extending packet sent from the DHCP client, in which the lease-extending packet may include the user information sub-option including operation information of the DHCP client.

The forwarding module 523 may forward the lease-extending packet to the DHCP server, so that the DHCP server may perform policy configuration to the DHCP client based on the operation information of the DHCP client.

According to an example of the present disclosure, the receiving module 521 may receive a REQUEST packet sent from the DHCP client, in which the REQUEST packet may include the user information sub-option including login information of the DHCP client.

The forwarding module 523 may forward the REQUEST packet to the DHCP server, so that a network administrator may log in the DHCP client according to the login information of the DHCP client collected by the DHCP server.

According to an example of the present disclosure, when the relay device serves as a DHCP client, the receiving module 521 may receive information about a next hop of the relay device in an access path towards a destination client, in which the information about the next hop may be included in an ACK packet sent by the DHCP server and issued by the DHCP server through a running routing protocol. The receiving module 521 may form a routing entry in the relay device, in which the routing entry may be configured to forward traffic to the destination client.

According to an example of the present disclosure, when the relay device serves as a DHCP client, the receiving module 521 may receive a correspondence relationship between an IP address and a MAC address of the DHCP client, in which the correspondence relationship may be included in an ACK packet sent from the DHCP server. The receiving module 521 may store the correspondence relationship, so that the DHCP client may validly use network resources based on the correspondence relationship.

The above-mentioned modules in the examples of the present disclosure may be deployed either in a centralized or a distributed configuration, and may be either merged into a single module, or further split into a plurality of sub-modules.

As may be seen from the above description that according to various examples of the present disclosure, the DHCP server determines network topology based on information sub-options including Option60 and Option82 received by the DHCP server, in which Option60 indicates a node identifier and Option82 indicates path information of a packet. In addition, the DHCP server receives operation information of each node device through Option60, so that traffic information of each node device can be displayed on the DHCP server in real time, and thus the network administrator can easily monitor the whole network. Further, the DHCP server receives login information of each node device through Option60, so that the network administrator can directly log in each node device. Moreover, solutions like issuing routing information by the DHCP server can be achieved through other Options. Through the method described in various examples of the present disclosure, the node devices may be managed conveniently.

The above examples may be implemented by hardware, software or firmware, or a combination thereof. For example, the various methods, processes and functional modules described herein may be implemented by a processor (the term processor is to be interpreted broadly to include a CPU, processing unit, ASIC, logic unit, or programmable gate array, etc.). The processes, methods, and functional modules disclosed herein may all be performed by a single processor or split between several processors. In addition, reference in this disclosure or the claims to a ‘processor’ should thus be interpreted to mean ‘one or more processors’. The processes, methods and functional modules disclosed herein may be implemented as machine readable instructions executable by one or more processors, hardware logic circuitry of the one or more processors or a combination thereof. Further the examples disclosed herein may be implemented in the form of a computer software product. The computer software product may be stored in a non-transitory storage medium and may include a plurality of instructions for making a computer apparatus (which may be a personal computer, a server or a network apparatus such as a router, switch, access point, etc.) implement the method recited in the examples of the present disclosure.

All or part of the procedures of the methods of the above examples may be implemented by hardware modules following machine readable instructions. The machine readable instructions may be stored in a computer readable storage medium. When running, the machine readable instructions may provide the procedures of the method examples. The storage medium may be diskette, CD, ROM (Read-Only Memory) or RAM (Random Access Memory), and etc.

The figures are only illustrations of examples, in which the modules or procedures shown in the figures may not be necessarily essential for implementing the present disclosure. The modules in the aforesaid examples may be combined into one module or further divided into a plurality of sub-modules.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. A method for forwarding a dynamic host configuration protocol (DHCP) packet, comprising:
receiving, by a relay device, a DHCP request packet sent from a DHCP client;
wherein the DHCP request packet comprises a user information sub-option comprising a node identifier of the DHCP client;
adding, by the relay device, a node identifier of the relay device and path information of receiving the DHCP request packet by the relay device to a relay agent information sub-option in the DHCP request packet; and
forwarding, by the relay device, the DHCP request packet to a DHCP server, so that the DHCP server determines network topology according to the user information sub-option and the relay agent information sub-option.

2. The method of claim 1, wherein the path information of receiving the DHCP request packet comprises information about an interface through which the relay device receives the DHCP request packet and information about an interface through which the relay device forwards the DHCP request packet.

3. The method of claim 1, wherein the DHCP server configures an internet protocol (IP) address and a lease for the DHCP client;
the method further comprising:
receiving, by the relay device, a lease-extending packet sent from the DHCP client;
wherein the lease-extending packet comprises the user information sub-option comprising operation information of the DHCP client; and
forwarding, by the relay device, the lease-extending packet to the DHCP server, so that the DHCP server perform policy configuration to the DHCP client based on the operation information of the DHCP client.

4. The method of claim 3, wherein the operation information of the DHCP client comprises any combination of information comprising CPU occupancy of the DHCP client, an interface state of each interface on the DHCP client, interface uplink traffic statistics, and interface downlink traffic statistics.

5. The method of claim 3, wherein the operation information of the DHCP client is stored in a remote server;
the method further comprising:
carrying, in the user information sub-option of the lease-extending packet, an address and a domain name of the remote server, and a user name and a password required for logging in the remote server.

6. The method of claim 1, wherein the DHCP server configures an IP address for the DHCP client;
the method further comprising:
receiving, by the relay device, a REQUEST packet sent from the DHCP client;
wherein the REQUEST packet comprises the user information sub-option comprising login information of the DHCP client; and
forwarding, by the relay device, the REQUEST packet to the DHCP server, so that a network administrator logs in the DHCP client according to the login information of the DHCP client collected by the DHCP server.

7. The method of claim 6, wherein the login information comprises:
a system identifier used by the DHCP client,
a network management mode employed by the DHCP client,
a service port number, a user name, and a password required for logging in the DHCP client, and
an address and a domain name of a remote server where the DHCP client remotely stores information, and a user name and a password required for logging in the remote server.

8. The method of claim 1, further comprising:
when the relay device serves as the DHCP client, receiving, by the relay device, information about a next hop of the relay device in an access path towards a destination client;
wherein the information about the next hop is issued by the DHCP server; and
forming a routing entry in the relay device based on the information about the next hop;
wherein the routing entry is to forward traffic to the destination client.

9. The method of claim 1, further comprising:
when the relay device serves as a second DHCP client, receiving, by the relay device, a correspondence relationship between an IP address and a media access control (MAC) address of the DHCP client;
wherein the correspondence relationship is issued by the DHCP server; and
storing, by the relay device, the correspondence relationship, so that the DHCP client validly accesses network resources based on the correspondence relationship.

10. A relay device, comprising:
a receiving module, to receive a DHCP request packet sent from a DHCP client;
wherein the DHCP request packet comprises a user information sub-option comprising a node identifier of the DHCP client;
an information adding module, to add a node identifier of the relay device and path information of receiving the DHCP request packet by the relay device to a relay agent information sub-option in the DHCP request packet; and
a forwarding module, to forward the DHCP request packet to a DHCP server, so that the DHCP server determines network topology according to the user information sub-option and the relay agent information sub-option.

11. The device of claim 10, wherein
the receiving module is to receive a lease-extending packet sent from the DHCP client;
wherein the lease-extending packet comprises the user information sub-option comprising operation information of the DHCP client; and
the forwarding module is to forward the lease-extending packet to the DHCP server, so that the DHCP server perform policy configuration to the DHCP client based on the operation information of the DHCP client.

12. The device of claim 10, wherein
the receiving module is to receive a REQUEST packet sent from the DHCP client;
wherein the REQUEST packet comprises the user information sub-option comprising login information of the DHCP client; and
the forwarding module is to forward the REQUEST packet to the DHCP server, so that a network administrator logs in the DHCP client according to the login information of the DHCP client collected by the DHCP server.

13. The device of claim 10, wherein
when the relay device serves as a second DHCP client, the receiving module is to
receive information about a next hop of the relay device in an access path towards a destination client, wherein the information about the next hop is issued by the DHCP server; and
form a routing entry in the relay device based on the information about the next hop; wherein the routing entry is to forward traffic to the destination client.

14. The device of claim 10, wherein
when the relay device serves as a second DHCP client, the receiving module is to
receive a correspondence relationship between an IP address and a media access control (MAC) address of the DHCP client; wherein the correspondence relationship is issued by the DHCP server; and
store the correspondence relationship, so that the DHCP client validly accesses network resources based on the correspondence relationship.
